(19) United States
(12) Patent Application Publication
(10) Pub. No.: US 2005/0072053 A1
(43) Pub. Date: Apr. 7, 2005

(54) Seal and molding assembly

(76) Inventors: Larry Andrew Filipczak, West Bloomfield, MI (US); Harry L. Renshaw III, Sterling Hts., MI (US); Michelle M. Koneval, Macomb Twp., MI (US)

Correspondence Address: General Motors Corporation;Legal Staff, Mail Code 482-C23-B21, P.O. Box 300, Detroit, MI, 48265-3000, US

(21) Appl. No.: 10/679,834

(22) Filed: Oct. 6, 2003

(51) Int. Cl. E06B 7/16

(52) U.S. Cl. 49/490.1

(57) ABSTRACT

A seal and molding assembly includes a first seal portion attached to a mounting surface of a first flanged connection point on an automobile door to retain the first seal portion on the automobile door. The first seal portion has a first projection and a hook flange extending therefrom. The assembly includes a second seal portion attached to a second flanged connection point on the automobile door and having a second projection extending therefrom. The hook flange and the second projection engage to retain the first and second seal portions on the automobile door.

### BACKGROUND OF THE INVENTION

The present invention relates in general to automobile body seals and moldings and, in particular, to an integrated seal and molding assembly for an automobile body.

Seals and seal assemblies are used extensively in the automotive industry for, among other purposes, preventing water and foreign objects from entering the vehicle interior. Seals are used around doors, door frames, and windowpanes in particular and are attached to mounting flanges on the door header. Door headers and their corresponding mounting flanges in recent designs have become smaller in width and/or length, which reduces the amount of surface upon which the seals and seal assemblies may be mounted and retained to the door header.

In addition, most door frames utilize a molding that defines and trims the top of the door header. This molding is mechanically attached with between five and eight screws or rivets, which is costly and labor intensive and is difficult to install due to the profile of the molding.

It is desirable, therefore, to provide a molding and seal assembly that requires reduced installation effort while also maximizing the force required to remove it from its mounting location. It is also desirable to provide an integrated reveal molding and seal retention system to increase manufacturing efficiency and to reduce the number of parts required for vehicle assembly.

### SUMMARY OF THE INVENTION

The present invention concerns a seal and molding assembly apparatus for an automobile body. The seal and molding assembly includes a first seal portion attached to a mounting surface of a first flanged connection point on an automobile door to retain the first seal portion on the automobile door. The first seal portion has a first projection and a hook flange extending therefrom. The assembly includes a second seal portion attached to a second flanged connection point on the automobile door and having a second projection extending therefrom. The hook flange and the second projection engage to retain the first and second seal portions on the automobile door.

The hook flange of the present invention allows for a mechanical attachment or interlock of the seal extrusion to the molding and is a more robust method of attaching an automotive weatherstrip, while also allowing for a reduced cross section size of the door header. The first projection is preferably J-shaped and the mounting surface on the first flanged connection point is preferably a mounting surface known in the art as the “beauty-step” or “gainer”. This mounting surface is found on all door inner panels as it is required to prevent wrinkling of the door sheet metal during the stamping process. The shape of the assembly allows for low insertion effort for the operators to install the part, as well as very high extraction effort for the removal of the assembly. The present invention advantageously allows for a reduction in the number of mechanical attachments because mechanical fasteners are required only at the fore and aft extremities of the molding portion.

The design of the present invention allows for improved ergonomics for the assembly plant operator along with a reduction in the number of parts, fasteners, and labor required for the installation of the seal and molding assembly.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a fragmentary cross sectional view of a prior art seal assembly; and

FIG. 2 is a fragmentary cross sectional view of an integrated seal and molding assembly in accordance with the present invention.

### DESCRIPTION OF THE PREFERRED EMBODIMENT

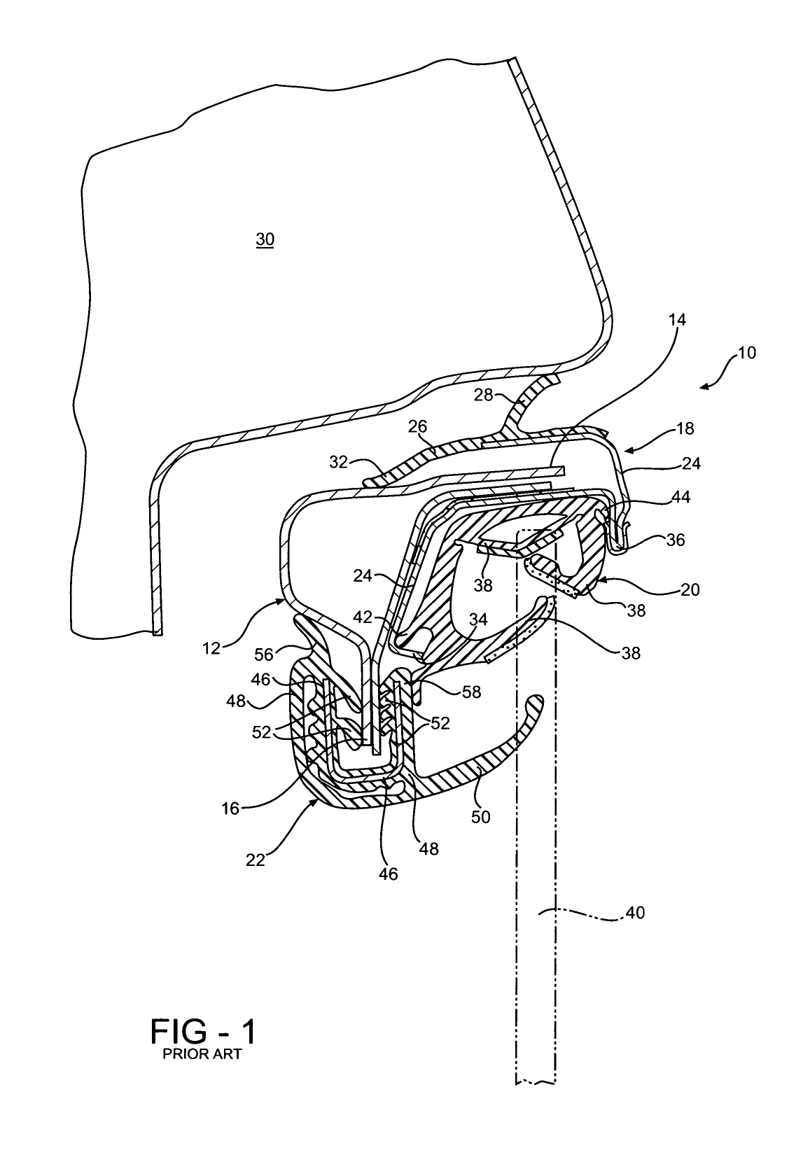

Referring now to FIG. 1, a door seal assembly in accordance with the prior art is indicated generally at 10. The door seal assembly 10 is adapted to be attached to a door header 12 at a first flanged connection point 14 and a second flanged connection point 16 thereof. The door seal assembly 10 includes a first or reveal molding portion 18, a second or glass seal portion 20, and a third or secondary seal portion 22. The door header 12 is typically an elongated member that runs the entire longitudinal length of an upper portion of an automobile door (not shown).

The reveal molding portion 18 is adapted to be attached to and surround the first flanged connection point 14. The reveal molding portion 18 includes a frame 24, typically formed of a metallic material, that is surrounded by a seal 26, typically formed of a rubber material or the like, on an upper portion thereof. The seal 26 includes a flange 28 extending upwardly therefrom that engages with a surface of an automobile body 30. The automobile body 30 typically includes a weatherstrip member (not shown) or similar type seal to seal the inboard surface of the door header 12. The seal 26 also includes a flange 32 extending inwardly therefrom. A free end of the flange 32 frictionally engages with a surface of the door header 12 adjacent the first flanged connection point 14 to assist in retaining the seal 26 to the door header 12. A lower portion of the frame 24 extends downwardly away from the first flanged connection point 14 and terminates in a lip 34 extending outwardly from a free end thereof. An outer portion of the frame 24 terminates in a lip 36 extending downwardly from an end thereof.

The reveal molding portion 18 of the door seal assembly 10, however, must be disadvantageously secured to the door header 12 by a plurality of fasteners (not shown) along a great portion of the longitudinal length thereof because the interaction of the respective surfaces of the flange 32 and the door header 12 is insufficient for retention of the reveal molding portion 18. In addition, there is an inherent difficulty in loading the reveal molding portion onto the first flanged connection point 14 because, during installation, the free end of the flange 32 engages with the exterior surface of the door header 12 and disadvantageously tends to resist inward movement along the first flanged connection point 14.

The glass seal portion 20 is typically a rubber extruded member that is pressed into place after the reveal molding portion 18 has been attached to the first flanged connection point 14. The glass seal portion 20 includes a plurality of flanges 38 extending therefrom for receiving and engaging with a glass windowpane 40 therein. When the glass seal portion 20 is pressed into place, a projection 42 engages with the lip 34 and a projection 44 engages with the lip 36, securing the glass seal portion 20 to the reveal molding portion 18.

The secondary seal portion 22 is adapted to be attached to and surround the second flanged connection point 16. The secondary seal portion 22 is typically pressed into place after the reveal molding portion 18 and the glass seal portion 20 have been attached to the door header 12. The secondary seal portion 22 includes a carrier, spine, or frame 46, typically formed of a metallic material, that is surrounded by a seal 48, typically formed of a rubber material or the like. The seal 48 of the secondary seal portion 22 includes a flange 50 extending therefrom for engaging with the glass windowpane 40. The seal 48 of the secondary seal portion 22 includes a plurality of projections 52 extending inwardly therefrom for engaging with the exterior surface of the second flanged connection point 16. Another flange 56 extends from an upper portion of the seal 48 and engages with an exterior surface of the door header 12 adjacent the second flanged connection point 16. When the secondary seal portion 22 is pressed into place, the projections 52 frictionally engage with the exterior surface of the second flanged connection point 16, the flange 56 frictionally engages with the exterior surface of the door header 12, and a projection 58 extending from a lower portion of the glass seal portion 20 frictionally engages with an exterior surface of the seal 48, securing the secondary seal portion 22 to the second flanged connection point 16.

The assembly 10, therefore, disadvantageously requires a three step installation process. First, the reveal molding portion 18 is installed and secured by the five to eight fasteners, followed by the installation of the glass seal portion 20, which is in turn followed by the installation of the secondary seal portion 22.

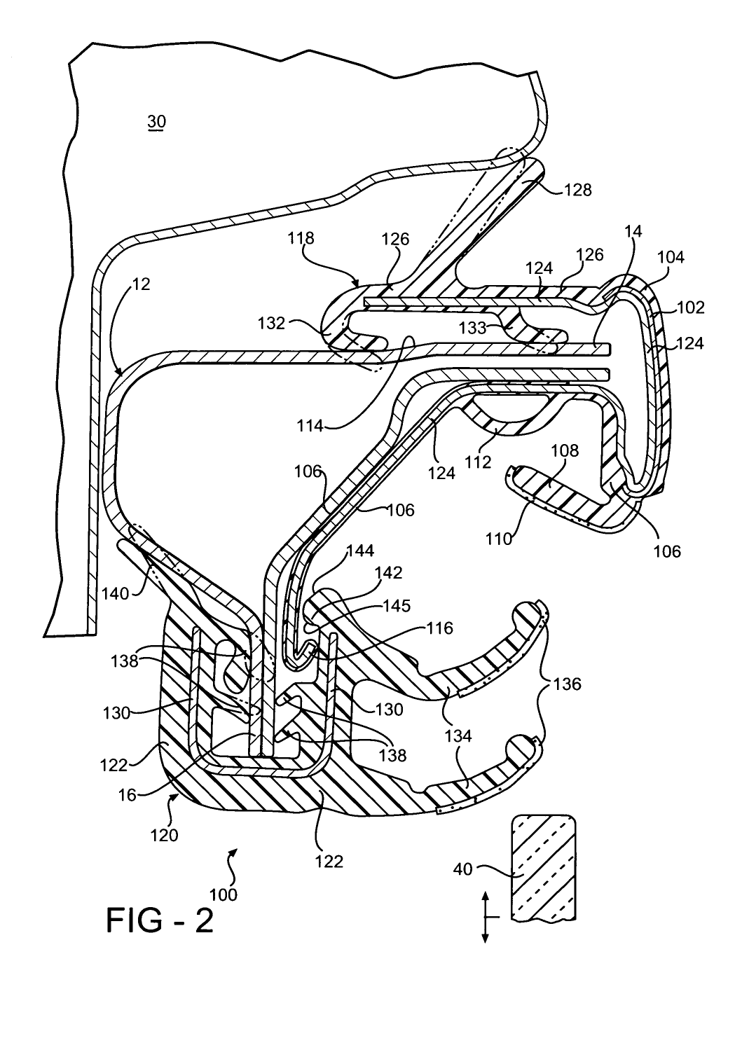

Referring now to FIG. 2, an integrated seal and reveal molding assembly in accordance with the present invention is indicated generally at 100. The assembly 100 is adapted to be attached to the door header 12 at the first flanged connection point 14 and the second flanged connection point 16 thereof. The assembly 100 includes a first or reveal molding and seal portion 118 and a second or secondary seal portion 120.

The first portion 118 is adapted to be attached to and surround the first flanged connection point 14. The first portion 118 includes a carrier or frame 124, preferably formed of a metallic material, that is surrounded by an elastomeric upper seal 126, preferably formed of a rubber material or the like, on an upper portion thereof. The upper seal 126 includes a flange 128 extending upwardly therefrom that engages with a surface of the automobile body 30. The upper seal 126 also includes a generally J-shaped or hook shaped projection 132 and another projection 133 extending inwardly and downwardly therefrom. An exterior surface of the projection 132 frictionally engages with an upwardly projecting mounting surface 114 on an exterior surface of the door header 12 adjacent the first flanged connection point 14 to firmly engage the upper seal 126 with the door header 12. The mounting surface 114 is stepped and is required to prevent wrinkling of the sheet metal of the door header 12 during the stamping process and, therefore, is advantageously found on most automobile door headers. Due to the respective profiles of the projection 132 and the mounting surface 114, a large surface area of the projection 132 frictionally engages with the mounting surface 114. The curved free end of the projection 132 does not tend to resist inward movement along the first flanged connection point 14 during installation. An exterior surface of the projection 133 further frictionally engages the exterior surface of the door header 12. Because of the firm engagement between the projection 132 and the mounting surface 114 and between the projection 133 and the exterior surface of the first flanged connection point 14, the first portion 118 of the assembly 100 requires far fewer fasteners (not shown) than the portion 18 of the prior art assembly 10 when the assembly 100 is attached to the first flanged connection point 14. Preferably, the first portion 118 requires only one fastener on each opposed end (not shown) of the door header 12.

An outer portion of the frame 124 includes a cap member 102 attached thereto. The cap member 102 is preferably formed of stainless steel or similar material. The cap member 102, in turn, includes a molding member 104 attached to an exterior surface thereof. The molding member 104 is preferably formed of a rubber material or similar material. A lower portion of the frame 124 includes an elastomeric lower seal 106 affixed on an exterior surface thereof. The lower seal 106 is attached on opposing exterior surfaces of the frame 124, advantageously absorbing any vibration forces transmitted from the door header 12 to the frame 124 and receiving and engaging with an exterior surface of the windowpane 40, discussed in more detail below. A projection 108 extends inwardly from a portion of the lower seal 106 adjacent a lower end of the cap member 102 and the molding 104. The projection 108 includes a coating 110 formed on an exterior surface thereof for smooth engagement with the windowpane 40. The coating 110 is preferably a flocking-type coating or similar type coating. A bumper 112 extends from an upper portion of the lower seal 106 for engaging and sealing an upper surface of the windowpane 40 when the windowpane 40 is moved to a closed position.

A hook flange 116 is formed on a free end of a lower portion of the frame 124. The hook flange 116 extends outwardly and upwardly from the free end of the frame 124. The lower seal 106 extends around the hook flange 116 for easier engagement with the second portion 120 when the second portion 120 is attached to the first portion 118, discussed in more detail below.

The frame 124 and the seals 106 and 126 are preferably co-extruded as an elongated and unitary first portion 118, which advantageously assists the installer of the part when the assembly 100 is attached to the door header 12.

The second portion 120 of the assembly 100 is adapted to be attached to and surround the second flanged connection point 16. The second portion 120 is preferably pressed into place after the first portion 118 has been attached to the door header 12. The second portion 120 includes a frame 130, preferably formed of a metallic material, that is surrounded by an seal 122, preferably formed of a rubber material or the like. The frame 130 and the seal 122 are preferably co-extruded as an elongated and unitary second portion 120. The seal 122 of the second portion 120 includes a plurality of flanges 134 extending therefrom for engaging with the glass windowpane 40. The flanges 134 each include a coating 136 formed on an exterior surface thereof for smooth engagement with the windowpane 40. The coating 136 is preferably a flocking-type coating or similar type coating. The seal 122 of the second portion 120 includes a plurality of projections 138 extending inwardly therefrom for frictionally engaging with the exterior surface of the second flanged connection point 16. Another flange 140 extends from an upper portion of the seal 122 and frictionally engages with an exterior surface of the door header 12 adjacent the second flanged connection point 16. A projection 142 extends inwardly from an upper surface of the second portion 120 adjacent the flanges 134. When the second portion 120 is pressed into place, the projections 138 engage with the exterior surface of the second flanged connection point 16 and the flange 140 engages with the exterior surface of the door header 12. The projection 142 deflects outwardly when an upper sloped surface 144 thereof is placed in contact with a lower surface of the hook flange 116 and, as an upward force presses the second portion 120 into place, the interior surface of the projection 142 travels beyond the hook flange 116, springing back to the position shown in FIG. 2. A lower stepped surface 145 of the projection 142 is now adjacent the hook flange 116. The amount of force required to install the second portion 120 on to the first portion 118 is significantly less than the force required to extract the second portion 120 from the first portion 118 because of the interaction between the hook flange 116 and the lower stepped surface 145. These interacting surfaces robustly secure the second portion 120 to the first portion 118 and to the second flanged connection point 16.

The assembly 100 in accordance with the present invention, therefore, requires only a two step installation process rather than the three step installation process required for the assembly 10 of the prior art. During assembly, the first portion 118 is installed, secured with a pair of fasteners, and the second portion 120 is installed. The two step installation of the assembly 100 requires far less time than the three step installation of the prior art assembly 10. The assembly 100 is also provides easier attachment of the first portion 118 to the door header 12 and a greater required extraction force than the prior art assembly 10.

The features of the assembly 100 may be combined or utilized separately, advantageously providing flexibility in the design of the seal assembly 100. For example, the assembly 100 may include one of, or both of, the projections 132 and 133 and the hook flange 116, while remaining within the scope of the present invention. If the assembly 100 includes only the projections 132 and 133, the first portion 118 may be combined with the glass seal portion 20 and the secondary seal portion 22 of FIG. 1. Conversely, if the assembly 100 includes only the hook flange 116, the first portion 118 includes the projection 32 rather than the projections 132 and 133 and first portion 118 is attached to the door header 12 by a plurality of fasteners (not shown) as in the prior art assembly 10.

The hook flange 116 may be used in any number of seal assembly applications including, but not limited to, sunroof seal assemblies, door primary seal assemblies, upper auxiliary seal assemblies, and any other type of assembly where low insertion effort and high extraction effort for the removal of the assembly are desirable. In addition, those skilled in the art will appreciate that the hook flange 116 of the frame 106 may be formed in any number of shapes including, but not limited to, a projection having a U-cross section, a triangular-shaped cross section, a semicircular shaped cross section, or any other barb-type projection that could engage with a surface such as, but not limited to, the lower stepped surface 145 of the projection 142 and provide low insertion efforts and high removal efforts for the assembly 100.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A seal and molding assembly for sealing an automobile door to an automobile body, comprising:
a first seal portion adapted to be attached to a first flanged connection point on an automobile door header, said first seal portion including a hook flange extending therefrom; and
a second seal portion adapted to be attached to a second flanged connection point on the automobile door header, said second seal portion including a projection extending therefrom,
whereby when said first seal portion is attached to the first flanged connection point and said second seal portion is attached to the second flanged connection point, said hook flange and said projection engage to retain said first and second seal members to the automobile door header.

2. The assembly according to claim 1 wherein said first seal portion is a reveal molding portion.

3. The assembly according to claim 1 wherein said second seal portion is a secondary seal portion.

4. The assembly according to claim 1 wherein said projection on said second seal portion includes an upper sloped surface and a lower stepped surface.

5. The assembly according to claim 1 wherein said first seal portion is a co-extruded member including a frame at least partially surrounded by an elastomeric material seal.

6. The assembly according to claim 1 wherein said second seal portion is a co-extruded member including a frame at least partially surrounded by an elastomeric material seal.

7. A reveal molding assembly for an automobile door, comprising:
a metal frame;
an elastomeric material seal at least partially surrounding said metal frame;
at least one outwardly extending projection formed on said seal; and
a molding member attached to said seal,
whereby when the reveal molding assembly is mounted on a flanged connection point of an automobile door header, said at least one projection frictionally engages with a mounting surface on the automobile door header adjacent the flanged connection point to retain the reveal molding assembly to the automobile door header.

8. The assembly according to claim 7 wherein said at least one projection is a J-shaped projection.

9. The assembly according to claim 7 wherein the mounting surface is a stepped surface adjacent the first flanged connection point.

10. The assembly according to claim 7 wherein said metal frame and said elastomeric material seal are co-extruded.

11. The assembly according to claim 7 including at least another projection formed by said seal for frictionally engaging with the flanged connection point.

12. A seal and molding assembly for an automobile door, comprising:
a seal and molding portion adapted to be attached to a first flanged connection point on an automobile door header, the first flanged connection point having a mounting surface formed thereon, said seal and molding portion including a metal frame and an elastomeric material seal at least partially surrounding said metal frame, said seal forming a first projection and said frame having a hook flange extending therefrom; and
a seal portion adapted to be attached to a second flanged connection point on the automobile door header, said seal portion including a second projection extending therefrom,
whereby when said seal and molding portion is attached to the first flanged connection point and said seal portion is attached to the second flanged connection point, said first projection frictionally engages with the mounting surface on the first flanged connection point to retain said seal and molding portion to the automobile door header and said hook flange engages said second projection to retain said seal and molding portion and said seal portion on the automobile door header.

13. The assembly according to claim 12 including at least a third projection formed by said seal and frictionally engaging with the first flanged connection point.

14. The assembly according to claim 12 wherein said frame and said seal are co-extruded.

15. The assembly according to claim 12 wherein said second projection has an upper sloped surface formed thereon whereby when said seal portion is being installed on the second flanged connection point after said seal and molding portion is installed on the first flanged connection point, said upper sloped surface engages said hook flange deflecting said second projection outwardly to reduce an amount of force required to install said seal portion on the second flanged connection point.

16. The assembly according to claim 12 wherein said second projection has a lower stepped surface formed thereon for engaging said hook flange and resisting removal of said seal portion from the second flanged connection point.

17. The assembly according to claim 12 wherein said first projection is a J-shaped projection.

18. The assembly according to claim 12 wherein the mounting surface is a stepped surface adjacent the first flanged connection point.

19. The assembly according to claim 12 wherein said seal and molding portion is a reveal molding portion.

20. The assembly according to claim 12 wherein said seal portion is a secondary seal portion.
